(19) United States
(12) Patent Application Publication
(10) Pub. No.: US 2025/0254104 A1
(43) Pub. Date: Aug. 7, 2025

(54) METHOD AND ELECTRONIC DEVICE FOR HANDLING SENSORY PERCEPTION OF USER IN INTERNET OF THINGS ENVIRONMENT

(71) Applicant: SAMSUNG ELECTRONICS CO., LTD., Suwon-si (KR)

(72) Inventors: Ankit Jain, Bengaluru (IN); Siba Prasad Samal, Bengaluru (IN); Suyambulingam Rathinasamy Muthupandi, Bengaluru (IN); Mukunth A, Bengaluru (IN); Jay Sharma, Bengaluru (IN); Chiranjeevi Achooru Ravishekar Hedge, Bengaluru (IN); Kishore Chandra Sahoo, Bengaluru (IN)

(73) Assignee: SAMSUNG ELECTRONICS CO., LTD., Suwon-si (KR)

(21) Appl. No.: 19/187,512

(22) Filed: Apr. 23, 2025

Related U.S. Application Data
(63) Continuation of application No. PCT/IB2024/050828, filed on Jan. 30, 2024.

(30) Foreign Application Priority Data
Jan. 30, 2023 (IN) 202341005904

(51) Int. Cl. H04L 41/16; G16Y 20/40; G16Y 40/35; H04L 67/12; H04L 67/306; H04W 24/02; H04W 84/18

(52) U.S. Cl. CPC H04L 41/16; G16Y 20/40; G16Y 40/35; H04L 67/306; H04W 24/02; H04L 67/12; H04W 84/18

(57) ABSTRACT

A control method of an electronic device, for handling determined sensory perception changes of a user in an Internet of Things (IoT) environment, includes measuring at least one first sensory parameter of at least one first IoT device in the IoT environment, wherein the at least one first sensory parameter indicates a determined sensory perception change of the user based on the user using the at least one first IoT device over a first period of time; identifying at least one second IoT device in the IoT environment used by the user after the at least one first IoT device, wherein the at least one second IoT device is operating in a first configuration; and controlling the at least one second IoT device to switch from the first configuration to a second configuration based on the at least one first sensory parameter.

### CROSS-REFERENCE TO RELATED APPLICATION

This application is a by-pass continuation application of International Application No. PCT/IB 2024/050828, filed on Jan. 30, 2024, which is based on and claims priority to Indian Patent Application number 202341005904, filed on Jan. 30, 2023, in the Indian Patent Office, the disclosures of which are incorporated by reference herein in their entireties.

### 1. FIELD

The present disclosure relates to an electronic device, and related to a method and the electronic device for handling sensory perception(s) of a user in an Internet of Things (IoT) environment.

### 2. DESCRIPTION OF RELATED ART

Sensory perceptions of a user is an ability to process stimuli in environment and the sensory perception is accomplished through coordination of sense organs and the brain. Any human being possesses five senses such as touch, hearing, taste, smell, and vision, as illustrated in operation 1 of FIG. 1. Detecting, recognizing, characterizing, and responding to stimuli are all part of the sensory perception. Sensory perception includes something in the real world stimulating the user's sense organs. For example, light reflected from a surface stimulates user's eyes. A hot cup of beverage stimulates touch senses. This stimulus is then converted into a neurogenic signal and is sent to the brain.

Internet of Things (IoT) devices are used for various purposes for different durations of time. Longer usage of an IoT device may alter user's sensory perceptions such as hearing capacity, focus, and understanding among other things, which results in degrading user experience due to changes in temporary sensory perception of the user. For example, as shown in operation 2, the user has been listening to music through headphones for more than five hours and the user turns on a Television (TV) to watch a favorite television show at a later point in time. The user may be unable to hear a normal sound associated with the favorite TV show due to prolonged use of the headphones. As a result, in operation 3, the user may manually change or control (e.g. increase) the sound associated with the TV, which may create discomfort or provide a poor user experience due to the temporary sensory perception changes.

Existing methods and systems may not include mechanisms for determining changes in sensory perception caused by prolonged use of IoT devices, and such methods and systems may also fail to counteract changes when a user uses a subsequent IoT device.

### SUMMARY

According to an aspect of the disclosure, a control method of an electronic device, for handling determined sensory perception changes of a user in an Internet of Things (IoT) environment, includes measuring at least one first sensory parameter of at least one first IoT device in the IoT environment, wherein the at least one first sensory parameter indicates a determined sensory perception change of the user based on the user using the at least one first IoT device over a first period of time; identifying at least one second IoT device in the IoT environment used by the user after the at least one first IoT device, wherein the at least one second IoT device is operating in a first configuration; and controlling the at least one second IoT device to switch from the first configuration to a second configuration based on the at least one first sensory parameter.

The control method may further include, based on the user using the at least one second IoT device, identifying whether a second period of time is reached indicating the determined sensory perception change of the user has reverted to a prior state; and controlling, based on the second period of time being reached, the at least one second IoT device to switch from the second configuration to the first configuration.

The controlling the at least one second IoT device to switch from the first configuration to the second configuration may include determining an impact level of the first period of time on the determined sensory perception of the user; determining a discomfort level for operating the at least one second IoT device based on a first relationship between at least one second sensory parameter of the at least one second IoT device and the impact level; determining an impact duration for the impact level based on the first period of time; determining at least one third sensory parameter of the at least one second IoT device affecting the determined sensory perception of the user while using the at least one second IoT device; determining, based on the at least one third sensory parameter, at least one counteracting sensory parameter of the at least one second IoT device for offsetting the impact level; determining the second configuration based on the impact duration and the at least one counteracting sensory parameter such that the discomfort level is reduced; and controlling the at least one second IoT device to switch from the first configuration to the second configuration.

The determining the impact level may include determining a user profile; determining, based on the user profile, a second relationship between the at least one first sensory parameter and the first period of time; and determining the impact level based on the second relationship.

The impact level may be determined based on at least one Machine Learning (ML) model.

The measuring the at least one first sensory parameter may include identifying a first plurality of sensory parameters of the at least one first IoT device based on the user using the at least one first IoT device; determining one or more sensory parameters from among the first plurality of sensory parameters corresponding to the first period of time, wherein the one or more sensory parameters may include the at least one first sensory parameter; and measuring the at least one first sensory parameter.

The identifying the at least one second IoT device may include identifying, based on receiving information from at least one sensor of an IoT device in the IoT environment, a movement of the user toward the at least one second IoT device; determining a user intent based on at least one of past user interaction data for the at least one second IoT device and current context data of the electronic device or received from the at least one first IoT device; and predicting the at least one second IoT device based on at least one of the movement or the user intent.

The controlling the at least one second IoT device to switch from the second configuration to the first configuration may include determining, based on at least one Machine Learning (ML) model, at least one correction value of at least one counteracting sensory parameter of the at least one second IoT device; determining the second period of time based on the at least one correction value; and based on the second period of time being reached, controlling the at least one second IoT device to switch to the first configuration from the second configuration. The at least one second sensory parameter of the at least one second IoT device may not indicate the determined sensory perception change.

The first period of time may indicate a prolonged usage of the at least one first IoT device by the user in the IoT environment, and the prolonged usage may be determined based on a real-time usage duration of the at least one first IoT device, a reference usage duration of the at least one first IoT device, a user profile, and current contextual parameter.

The real-time usage duration may be determined based on real-time sensor data received from the at least one first IoT device, and the reference usage duration may be determined based on pre-defined global usage data.

The control method may further include controlling the at least one second IoT device to switch from the first configuration to the second configuration such that an increase in a discomfort level caused by a sudden change between the at least one first sensory parameter and at least one second sensory parameter of the at least one second IoT device is reduced.

According to an aspect of the disclosure, an electronic device, for handling determined sensory perception changes of a user in an Internet of Things (IoT) environment, includes memory storing instructions; and one or more processors, wherein the instructions, when executed by the one or more processors, cause the electronic device to measure at least one first sensory parameter of at least one first IoT device in the IoT environment, wherein the at least one first sensory parameter indicates a determined sensory perception change of the user based on the user using the at least one first IoT device over a first period of time; identify at least one second IoT device in the IoT environment used by the user after the at least one first IoT device, wherein the at least one second IoT device is operating in a first configuration; and control the at least one second IoT device to switch from the first configuration to a second configuration based on the at least one first sensory parameter.

The instructions, when executed by the one or more processors, may further cause the electronic device to, based on the user using the at least one second IoT device, identify whether a second period of time is reached indicating the determined sensory perception change of the user has reverted to a prior state; and control, based on the second period of time being reached, the at least one second IoT device to switch from the second configuration to the first configuration.

The instructions, when executed by the one or more processors, may cause the electronic device to determine an impact level of the first period of time on the determined sensory perception of the user; determine a discomfort level for operating the at least one second IoT device based on a first relationship between at least one second sensory parameter of the at least one second IoT device and the impact level; determine an impact duration for the impact level based on the first period of time; determine at least one third sensory parameter of the at least one second IoT device affecting the determined sensory perception of the user while using the at least one second IoT device; determine, based on the at least one third sensory parameter, at least one counteracting sensory parameter of the at least one second IoT device for offsetting the impact level; determine the second configuration based on the impact duration and the at least one counteracting sensory parameter such that the discomfort level is reduced; and control the at least one second IoT device to switch from the first configuration to the second configuration.

The instructions, when executed by the one or more processors, may cause the electronic device to determine a user profile; determine, based on the user profile, a second relationship between the at least one first sensory parameter and the first period of time; and determine the impact level based on the second relationship.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1 illustrates a problem scenario in an existing mechanism to handle a sensory perception(s) of a user in an Internet of Things (IoT) environment, according to prior art;

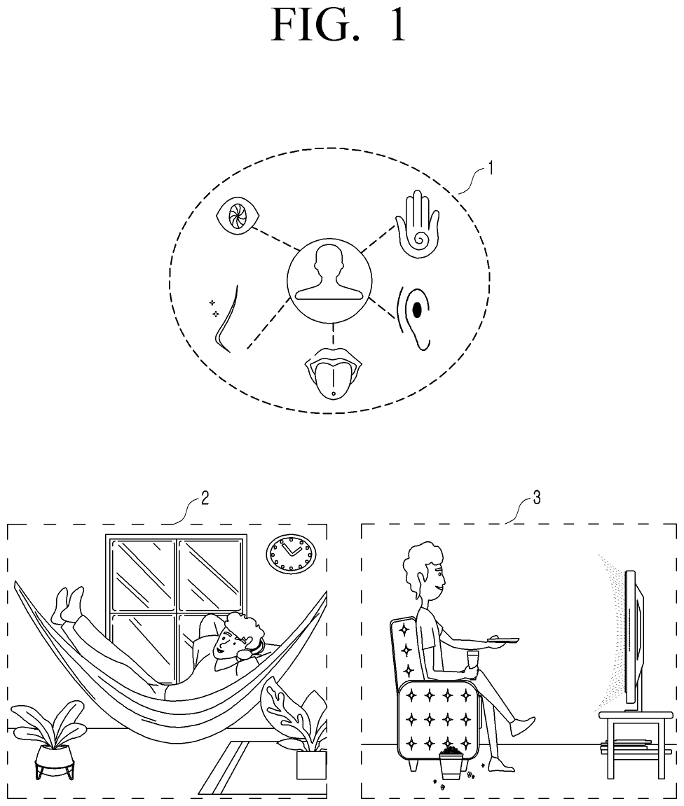

FIG. 2 illustrates a block diagram of an electronic device for handling the sensory perception(s) of the user in the IoT environment, according to an embodiment as disclosed herein;

FIG. 3 is a flow diagram illustrating a method for handling the sensory perception(s) of the user in the IoT environment, according to an embodiment as disclosed herein;

FIG. 4 is an example flow diagram illustrating various operations for handling an auditory sensory perception(s) of the user associated with a second IoT device(s), according to an embodiment as disclosed herein;

FIG. 5 is an example flow diagram illustrating various operations for handling the auditory sensory perception(s) of the user associated with the second IoT device(s), according to another embodiment as disclosed herein;

FIG. 6 is an example flow diagram illustrating various operations for handling a visual sensory perception(s) of the user associated with the second IoT device(s), according to an embodiment as disclosed herein;

FIG. 7 is an example flow diagram illustrating various operations for handling a touch sensory perception(s) of the user associated with the second IoT device(s), according to an embodiment as disclosed herein; and

FIG. 8 is an example flow diagram illustrating various operations for handling the visual sensory perception(s) of the user associated with the second IoT device(s), according to another embodiment as disclosed herein.

FIG. 9 is an example flow diagram illustrating various operations for handling the visual sensory perception(s) of the user associated with the second IoT device(s) (100b), according to another embodiment as disclosed herein.

### DETAILED DESCRIPTION

The embodiments described in the disclosure, and the configurations shown in the drawings, are only examples of embodiments, and various modifications may be made without departing from the scope and spirit of the disclosure.

The various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended to facilitate an understanding of ways in which the embodiments herein can be practiced and to further enable those skilled in the art to practice the embodiments herein. Accordingly, the examples should not be construed as limiting the scope of the disclosure.

The expressions “at least one of A, B and C” and “at least one of A, B, or C”, both indicate “A”, only “B”, only “C”, both “A and B”, both “A and C”, both “B and C”, and all of “A, B, and C”.

Embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help understand various technical features and it should be understood that the embodiments presented herein are not limited by the accompanying drawings. As such, the present disclosure should be construed to extend to any alterations, equivalents, and substitutes in addition to those which are set out in the accompanying drawings. Although the terms first, second, for example, may be used herein to describe various elements, these elements should not be limited by these terms. These terms are used to distinguish one element from another.

Throughout this disclosure, the terms “sensory parameter(s)” and “capability parameter” are used interchangeably and mean the same. Throughout this disclosure, the terms “counteracting sensory parameter(s)” and “counteracting capability parameter” are used interchangeably and mean the same.

In the existing mechanism or electronic device, there is no way to determine a level of impact on sensory perception(s) of a user due to prolonged usage of an electronic device/first IoT device(s) (e.g., headphones). For example, the user (Alan) is listening to music through headphones for more than five hours. After some time has passed, the user turns on a television to watch his favorite television show. The user is unable to hear a normal sound or the user has an issue with audio clarity associated with his favorite television show due to prolonged use of the headphones, which gives the user a bad experience/discomfort because of the temporary sensory perception changes caused by the electronic device/first IoT device(s) (for example, headphones) ruin the user experience on the subsequent second electronic device (for example, T.V).

In the existing mechanism or electronic device, there is no way to automatically configure the subsequent second IoT device(s) when the sensory perception(s) of the user is changed due to prolonged usage of the electronic device/first IoT device(s). The user must manually configure the subsequent second IoT device(s). For example, the user (Alan) is exercising by using the electronic device/first IoT device(s) (e.g., treadmill). As a result, the user has begun to sweat, and the subsequent second IoT device(s) (e.g., smart-watch/touch devices) will be difficult to operate the second IoT device(s) as the change in touch sensory perception(s) due to prolonged usage of the electronic device/first IoT device(s). As a result, the user must manually configure the second IoT device(s). So, that the second electronic device can be accessed.

In the existing mechanism/electronic device, there is no way for automatically re-configuration or reverse configuration of the subsequent second IoT device(s) to its initial stage which was automatically configured by the electronic device/first IoT device(s) due to prolonged usage of the electronic device/first IoT device(s).

Embodiments herein provide a method for handling sensory perception of a user in an Internet of Things (IoT) environment. The method includes measuring, by an electronic device in the IoT environment, a sensory parameter(s) of first IoT device in the IoT environment indicating a sensory perception change of the user while accessing the first IoT device over a first period of time. The method includes detecting, by the electronic device, a second IoT device in the IoT environment accessing by the user subsequent to the first IoT device, where the second IoT device is operating in a first configuration. The method includes automatically configuring, by the electronic device, the second IoT device from the first configuration to a second configuration based on the measured sensory parameter(s) while accessing the first IoT device.

Embodiments herein provide the electronic device for handling the sensory perception of the user in the IoT environment. The electronic device includes a configuration controller coupled with a processor and a memory. The configuration controller measures the sensory parameter(s) of the first IoT device in the IoT environment indicating the sensory perception change of the user while accessing the first IoT device over a first period of time. The configuration controller detects second IoT device in the IoT environment accessing by the user subsequent to the first IoT device, wherein the second IoT device is operating in a first configuration. The method includes automatically configuring the second IoT device from the first configuration to a second configuration based on the measured sensory parameter(s) while accessing the first IoT device.

The proposed method allows the electronic device or first IoT device(s) to detect prolonged usage of an electronic device or first IoT device(s) by the user in the IoT environment; determine a level of impact on the sensory perception(s) of the user and duration of impact due to the prolonged usage; predict a second IoT device(s) of the IoT environment for future user interaction(s) while the sensory perception(s) of the user persists; and dynamically configure the predicted second IoT device(s) to handle the sensory perception(s) of the user in the IoT environment. As a result, the second IoT device(s) is automatically configured to avoid discomfort because of temporary sensory perception(s) changes caused by the first IoT device (e.g., headphones), which improves user experience on subsequent second IoT device(s) (e.g., TV).

The proposed method allows the electronic device/first IoT device(s) to determine a correction duration(s) and a correction value(s) associated with the dynamically configured second IoT device(s) and reconfigure the dynamically configured second IoT device(s) to an initial stage of the second IoT device(s) based on the determined correction duration(s) and the determined correction value(s). For example, after detecting prolonged use of the electronic device/first IoT device(s) (e.g., treadmill), the electronic device/first IoT device(s) automatically configured the second electronic device (e.g., A C) with the correction duration (e.g., 15 minutes) and the correction value (e.g., 18 degrees Celsius). When the correction duration is over, the second electronic device returns to the initial stage (e.g., 24 degrees Celsius).

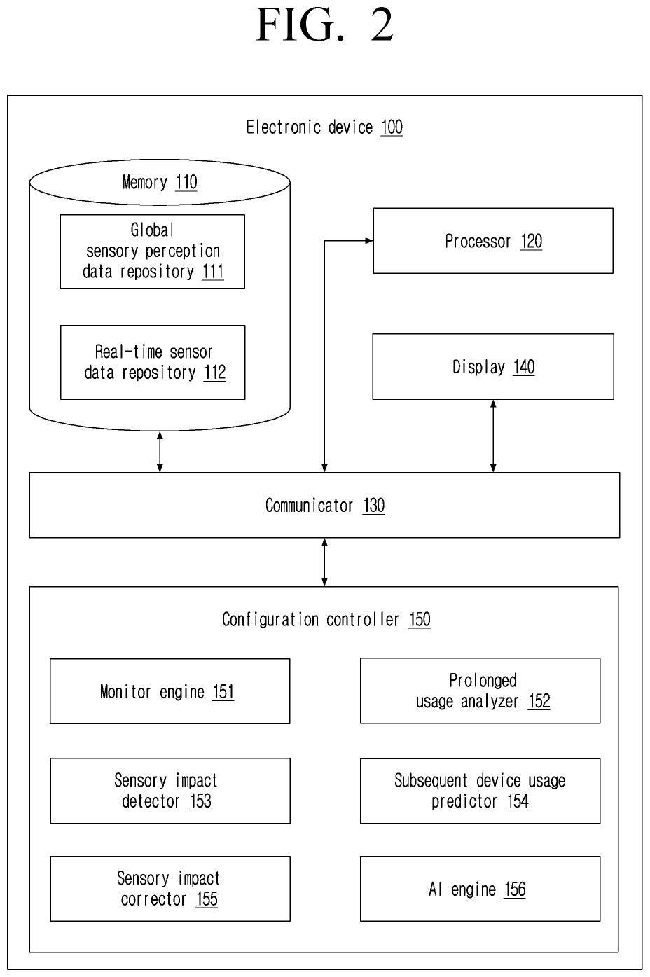

Referring now to the drawings, and FIGS. 2 through 8, where similar reference characters denote corresponding features consistently throughout the figures, there are shown embodiments.

FIG. 2 illustrates a block diagram of an electronic device (100) for handling the sensory perception(s) of the user in the IoT environment, according to an embodiment as disclosed herein. The electronic device (100) or a first IoT device(s) (100a) or a second IoT device(s) (100b) can be, for example, but not limited to a smart phone, a laptop, a desktop, a smart watch, a smart TV, Augmented Reality device (AR device), Virtual Reality device (VR device), Internet of Things (IoT) device or a like. The first IoT device(s) (100a) and/or the second IoT device(s) (100b) has same hardware architecture of the electronic device (100) and performs the same functions of the electronic device (100)

In an embodiment, the electronic device (100) includes a memory (110), a processor (120), a communicator (130), a display (140), and a configuration controller (150).

In an embodiment, the memory (110) stores a sensory parameter(s) while accessing the first IoT device(s) (100a) over a first period of time, a real-time usage duration of the first IoT device(s) (100a), a reference usage duration of the first IoT device(s) (100a), current contextual parameter, predicted second IoT device(s) (100b) in an IoT environment accessible by the user subsequent to the first IoT device(s) (100a), information associated with a first configuration and a second configuration, a level of impact on the sensory perception of the user in relation to the first period of time, a user profile, a duration of impact associated with the sensory perception of the user while accessing the first IoT device(s) (100a) over the first period of time, an affected sensory parameter(s) of the second IoT device(s) (100b) that has an impact on the sensory perception of the user while accessing the second IoT device(s) (100b), and a counteracting sensory parameter(s) of the second IoT device(s) (100b) to rectify the affected sensory parameter(s). The memory (110) includes a global sensory perception data repository (111) and a real-time sensor data repository (112).

The memory (110) stores instructions to be executed by the processor (120). The memory (110) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. The memory (110) may, in some examples, be considered a non-transitory storage medium. The term “non-transitory” may indicate that the storage medium is not embodied in a carrier wave or a propagated signal. The term “non-transitory” should not be interpreted that the memory (110) is non-movable. In some examples, the memory (110) can be configured to store larger amounts of information than the memory. In certain examples, a non-transitory storage medium may store data that can, over time, change (e.g., in Random Access Memory (RAM) or cache). The memory (110) can be an internal storage unit or it can be an external storage unit of the electronic device (100), a cloud storage, or any other type of external storage.

The processor (120) communicates with the memory (110), the communicator (130), a display (140), and the configuration controller (150). The processor (120) is configured to execute instructions stored in the memory (110) and to perform various processes. The processor (120) may include one or a plurality of processors, may be a Central Processing Unit (CPU), an Application Processor (AP), or the like, a Graphics-only Processing Unit such as a graphics processing unit (GPU), a Visual Processing Unit (VPU), and/or an Artificial Intelligence (AI) dedicated processor such as a Neural Processing Unit (NPU).

The communicator (130) is configured for communicating internally between internal hardware components and with external devices (e.g. eN odeB, gNodeB, server, second IoT device(s), for example) via one or more networks (e.g. Radio technology). The communicator (130) includes an electronic circuit relating to a standard that enables wired or wireless communication.

The display (140) can be a Liquid Crystal Display (LCD), a Light Emitting Diode (LED), an Organic Light-Emitting Diode (OLED), or another type of display that can also accept user inputs. Touch, swipe, drag, gesture, voice command, and other user inputs are examples of user inputs.

The configuration controller (150) measures a sensory parameter(s) of first IoT device (100a) in the IoT environment indicating a sensory perception change of the user while accessing the first IoT device (100a) over a first period of time. The configuration controller (150) detects the second IoT device (100b) in the IoT environment accessing by the user subsequent to the first IoT device (100a), where the second IoT device (100b) is operating in a first configuration. The configuration controller (150) automatically configures the second IoT device (100b) from the first configuration to a second configuration based on the measured sensory parameter(s) while accessing the first IoT device (100a).

In an embodiment, the configuration controller (150) detects whether a second period of time is reached at which the changed sensory perception of the user reverts back to a prior state while accessing the second IoT device (100b). The configuration controller (150) automatically re-configures the second IoT device (100b) from the second configuration to the first configuration in response to determining that the second period of time is reached.

In an embodiment, the configuration controller (150) determines a level of an impact on the sensory perception of the user in relation to the first period of time. The configuration controller (150) determines a discomfort of the user to operate the second IoT device (100b) by correlating sensory parameter(s) of the second IoT device (100b) with the level of the impact on the sensory perception. The configuration controller (150) determines a duration of the impact on the sensory perception of the user due to accessing the first IoT device (100a) over the first period of time. The configuration controller (150) determines sensory parameter(s) of the second IoT device (100b) that can impact on the sensory perception of the user while accessing the second IoT device (100b) subsequent to the first IoT device (100a). The configuration controller (150) determines counteracting sensory parameter(s) of the second IoT device (100b) to rectify the impact on the sensory perception based on the determined sensory parameter(s) of the second IoT device (100b). The configuration controller (150) determines the second configuration for the second IoT device (100b) based on the duration of the impact on the sensory perception of the user and the determined counteracting sensory parameter(s), where the second configuration for the second IoT device (100b) is determined to avoid the discomfort of the user to operate the second IoT device (100b). The configuration controller (150) automatically configures the second IoT device (100b) to the determined second configuration from the first configuration.

In an embodiment, the configuration controller (150) determines a user profile. The configuration controller (150) correlates the sensory parameter(s) of the first IoT device (100a) with the first period of time and the user profile. The configuration controller (150) determines the level of impact based on the correlation. In an embodiment, the level of impact on the sensory perception of the user in relation to the first period of time is determined by using Machine Learning (ML) model.

In an embodiment, the configuration controller (150) detects a plurality of sensory parameters of the first IoT device (100a) while using the first IoT device (100a). The configuration controller (150) determines one or more sensory parameters in the plurality of sensory parameters meets the first period of time while using the first IoT device (100a). The configuration controller (150) measures the sensory parameter(s) in the one or more sensory parameter(s) while using the first IoT device (100a).

In an embodiment, the configuration controller (150) detects a movement of the user towards the second IoT device (100b) using sensor of the electronic device (100) or IoT devices (100a, 100b) in the IoT environment. The configuration controller (150) determines a user intention to use the second IoT device (100b) based on of a past user interaction with the second IoT device (100b) and current context of the first IoT device (100a) or the electronic device. The configuration controller (150) predicts the second IoT device (100b) in the IoT environment accessible by the user subsequent to the first IoT device (100a) based on the detected movement or the determined user intention.

In an embodiment, the configuration controller (150) determines a correction value of counteracting sensory parameter(s) of the second IoT device (100b) using the Machine Learning (ML) model. The configuration controller (150) determines the second period of time based on the determined correction value. The configuration controller (150) automatically re-configures the second IoT device (100b) to the first configuration from the second configuration when the determined second period of time is reached after which the sensory parameter(s) does not indicating the sensory perception change of the user while accessing the second IoT device (100b). In an embodiment, the first period of time indicates a prolonged usage of the first IoT device (100a) by the user in the IoT environment, and the prolonged usage of the first IoT device (100a) is determined based on a real-time usage duration of the first IoT device (100a), a reference usage duration of the first IoT device (100a), a user profile, and current contextual parameter. In an embodiment, the real-time usage duration of the first IoT device (100a) is determined based on real-time sensor data of the first IoT device (100a), and the reference usage duration of the first IoT device (100a) is determined based on pre-defined global usage data.

In an embodiment, the configuration controller (150) automatically configures the second IoT device (100b) from the first configuration to the second configuration to minimize the discomfort caused by a sudden change in the sensory parameter(s).

The configuration controller (150) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In an embodiment, the configuration controller (150) includes a monitor engine (151), a prolonged usage analyzer (152), a sensory impact detector (153), a subsequent device usage predictor (154), a sensory impact corrector (155), and an AI engine (156).

The monitor engine (151) detects the first IoT device(s) (100a) (e.g., treadmill) and a second IoT device(s) (e.g., smart watch) in the IoT environment. The monitor engine (151) monitors a first period of time and the user profile, where the first period of time indicates a prolonged usage of the first IoT device(s) (100a) by the user in the IoT environment. The prolonged usage analyzer (152) determines the prolonged usage of the first IoT device(s) (100a) is determined based on a real-time usage duration (e.g., 1 Hour) of the first IoT device(s) (100a), a reference usage duration (e.g., 20 Minutes) of the first IoT device(s) (100a), a user profile, and current contextual parameter of the first IoT device(s) (100a). The real-time usage duration of the first IoT device(s) (100a) is determined based on the real-time sensor(s) data of the first IoT device(s) (100a), and the reference usage duration of the first IoT device(s) (100a) is determined based on pre-defined global usage data. The prolonged usage analyzer (152) fetches the pre-defined global usage data from the global sensory perception data repository (111) and stores the real-time sensor(s) data in the real-time sensor data repository (112).

The prolonged usage analyzer (152) measures plurality of sensory parameter(s) of the user while using the first IoT device(s) (100a). The prolonged usage analyzer (152) determines the sensory parameter(s) of the plurality of sensory parameter(s) meets the first period of time while using the first IoT device(s) (100a). The prolonged usage analyzer (152) detects the sensory parameter(s) as affecting the sensory perception of the user while using the first IoT device(s) (100a) (e.g., increase heart rate, body fat burn, for example).

The sensory impact detector (153) determines the level of impact (e.g., 45%) on the sensory perception of the user in relation to the first period of time. The level of impact on the sensory perception of the user in relation to the first period of time is determined by using a Machine Learning (ML) model(s). The sensory impact detector (153) determines the duration of impact (e.g., 30 Min) associated with the sensory perception of the user while accessing the first IoT device(s) (100a) over the first period of time.

The subsequent device usage predictor (154) detects a movement of the user towards the second IoT device(s) (100b) based on a sensor(s) of the first IoT device(s) (100a) and the second IoT device(s) (100b). The subsequent device usage predictor (154) determines a user intention to use the second IoT device(s) (100b) based on a past user interaction with the second IoT device(s) (100b) and/or current context of the first IoT device(s) (100a) or the electronic device. The subsequent device usage predictor (154) predicts the second IoT device(s) (100b) in the IoT environment accessible by the user subsequent to the first IoT device(s) (100a) based on the detected movement and the determined user intention.

The subsequent device usage predictor (154) correlates the sensory parameter(s) with the first period of time and the user profile. The subsequent device usage predictor (154) determines a discomfort of the user to operate the second IoT device(s) (100b) (e.g., touch with sweat) based on correlation. The subsequent device usage predictor (154) determines an affected sensory parameter(s) (e.g., unusable display) of the second IoT device(s) (100b) that has an impact on the sensory perception of the user while accessing the second IoT device(s) (100b).

The sensory impact corrector (155) determines a counteracting sensory parameter(s) (e.g., swimming mode on in smart watch) of the second IoT device to rectify the affected sensory parameter(s). The sensory impact corrector (155) determines the second configuration for the second IoT device(s) (100b) based on the determined affected sensory parameter(s) and the determined counteracting sensory parameter(s), where the second configuration for the second IoT device(s) (100b) is determined to avoid the discomfort of the user to operate the second IoT device(s) (100b). The sensory impact corrector (155) automatically configures the second IoT device(s) (100b) to the determined second configuration from the first configuration.

The sensory impact corrector (155) detects whether a second period of time is reached after which the sensory parameter(s) does not affect the sensory perception of the user while accessing the second IoT device(s) (100b) The sensory impact corrector (155) determines a correction value(s) (e.g., On, 50%) of the counteracting sensory parameter(s) of the second IoT device(s) (100b) using the ML model(s). The sensory impact corrector (155) determines the second period of time (e.g., 15 Min) based on the determined correction value(s). The sensory impact corrector (155) automatically re-configures the second IoT device(s) (100b) to the first configuration from the second configuration when the determined second period of time is reached after which the sensory parameter(s) does not affect the sensory perception of the user while accessing the second IoT device(s) (100b).

A function associated with the AI engine (156) (or said ML model) may be performed through the non-volatile memory, the volatile memory, and the processor (120). One or a plurality of processors controls the processing of the input data in accordance with a predefined operating rule or AI model stored in the non-volatile memory and the volatile memory. The predefined operating rule or AI model is provided through training or learning. Here, being provided through learning means that, by applying a learning algorithm to a plurality of learning data, a predefined operating rule or AI engine (156) of the desired characteristic is made. The learning may be performed in a device itself in which AI according to an embodiment is performed, and/o may be implemented through a separate server/system. The learning algorithm is a method for training a predetermined target device (for example, a robot) using a plurality of learning data to cause, allow, or control the target device to decide or predict. Examples of learning algorithms include, but are not limited to, supervised learning, unsupervised learning, semi-supervised learning, or reinforcement learning.

The AI engine (156) may include a plurality of neural network layers. Each layer has a plurality of weight values and performs a layer operation through a calculation of a previous layer and an operation of a plurality of weights. Examples of neural networks include, but are not limited to, Convolutional Neural Network (CNN), Deep Neural Network (DNN), Recurrent Neural Network (RNN), Restricted Boltzmann Machine (RBM), Deep Belief Network (DBN), Bidirectional Recurrent Deep Neural Network (BRDNN), Generative Adversarial Networks (GAN), and Deep Q-Networks.

Although the FIG. 2 shows various hardware components of the electronic device/first IoT device(s) (100) but it is to be understood that other embodiments are not limited thereon. In other embodiments, the electronic device (100) may include less or more number of components. The labels or names of the components are used for illustrative purpose and does not limit the scope of the disclosure. One or more components can be combined to perform the same or substantially similar functions to handle the sensory perception(s) of the user in the IoT environment.

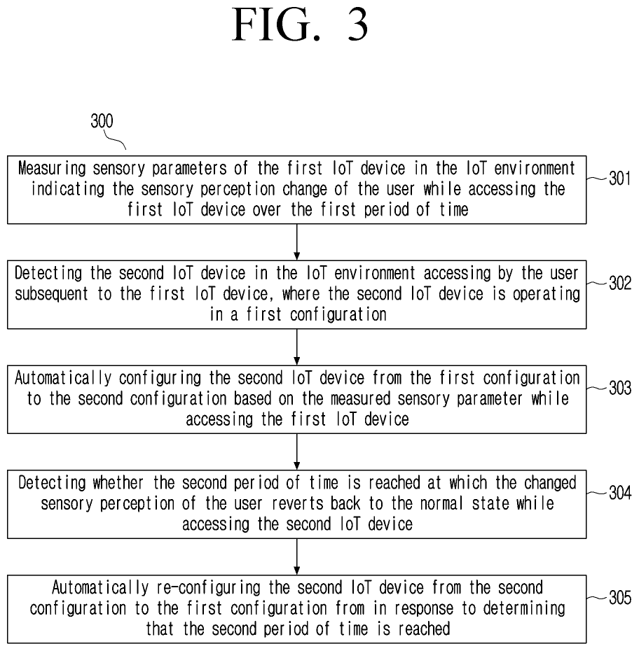

FIG. 3 is a flow diagram (300) illustrating a method for handling the sensory perception(s) of the user in the IoT environment, according to an embodiment as disclosed herein. The electronic device (100) performs various operations to handle the sensory perception(s) of the user in the IoT environment.

At operation 301, the method includes measuring sensory parameters of the first IoT device (100a) in the IoT environment indicating the sensory perception change of the user while accessing the first IoT device (100a) over the first period of time. At operation 302, the method includes detecting the second IoT device (100b) in the IoT environment accessing by the user subsequent to the first IoT device (100a), where the second IoT device (100b) is operating in a first configuration. At operation 303, the method includes automatically configuring the second IoT device (100b) from the first configuration to the second configuration based on the measured sensory parameter while accessing the first IoT device (100a). At operation 304, the method includes detecting whether the second period of time is reached at which the changed sensory perception of the user reverts back to the prior state while accessing the second IoT device (100b). At operation 305, the method includes automatically re-configuring the second IoT device (100b) from the second configuration to the first configuration in response to determining that the second period of time is reached.

The various actions, acts, blocks, operations, or the like in the flow diagram (300) may be performed in the order presented, in a different order, or simultaneously. In some embodiments, some of the actions, acts, blocks, operations, or the like may be added, modified, or the like without departing from the scope of the disclosure.

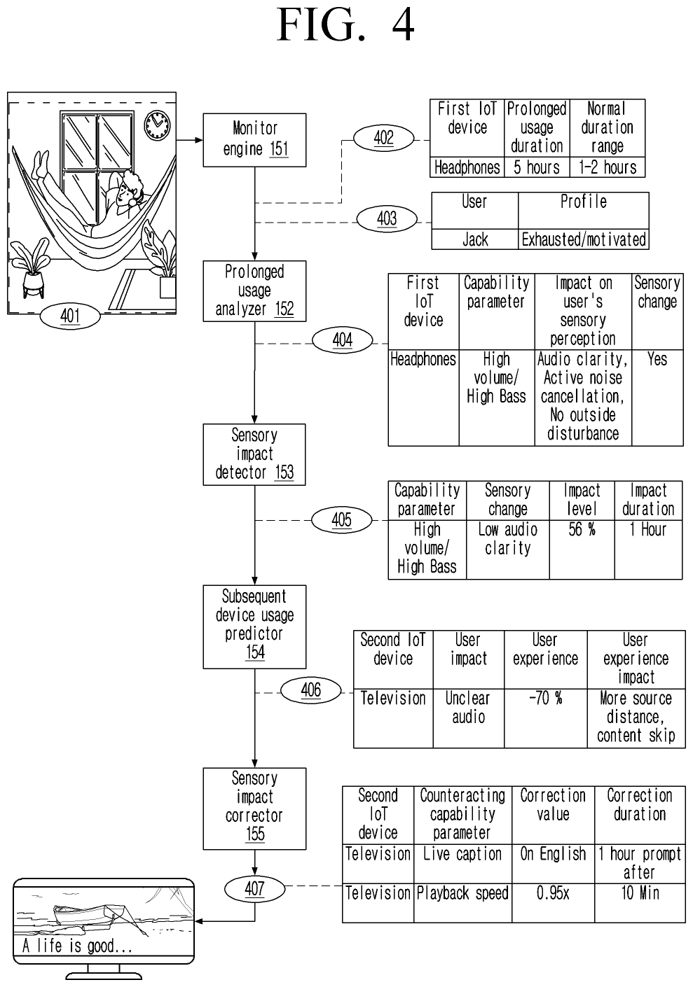

FIG. 4 is an example flow diagram illustrating various operations for handling an auditory sensory perception(s) of the user associated with the second IoT device(s) (100b), according to an embodiment as disclosed herein.

The user uses headphones while listening to music for a prolonged duration. The headphones temporarily alter the user's auditory sensory perception due to their prolonged duration(s). The temporary auditory sensory perception(s) changes caused by the headphones ruin the user experience on the subsequent IoT device(s) (e.g., television) that the user is about to use. To avoid this situation, the proposed method/electronic device (100) will automatically configure/reconfigure the next IoT device(s) to avoid discomfort caused by changes in auditory sensory perception(s). The proposed method/electronic device (100) activates live captioning on the television. As a result, the user can view subtitles while streaming shows and clearly understand the content being played on television. The proposed method is explained in detail below, operation by operation.

At operations 401-402, the monitor engine (151) determines the real-time usage duration of the first IoT device (100a) (for example headphones) and the normal usage duration range of the first IoT device (100a). If the real-time usage duration exceeds the normal usage duration range, then the monitor engine (151) identifies the real-time usage duration of the first IoT device (100a) as the prolonged usage duration of the first IoT device (100a). For example, if the user uses the headphones (100a) for the first period of time (for example 5 hours) that exceeds the normal usage duration range (for example 1-2 hours), the monitor engine (151) detects the prolonged use of the headphones (100a), for example, as shown in Table 1.

TABLE 1

| | Prolonged | Normal duration |
|---|---|---|
| First IoT device | usage duration | range |
| Headphones | 5 hours | 1-2 hours |

At operation 403, the monitor engine (151) identifies the user profile. The monitor engine (151) then sends information associated with the prolonged usage duration of the first IoT device (100a) and the identified user profile to the prolonged usage analyzer (152). At operation 404, the prolonged usage analyzer (152) determines one or more over-used capability parameters of the first IoT device (100a) that has an impact on the one or more sensory perceptions of the user while accessing the first IoT device (100a) over the first period of time, which may have difficulty hearing audio over long distances, for example, as shown in Table 2.

TABLE 2

| | | Impact on user's | |
|---|---|---|---|
| | Capability | sensory | |
| First IoT device | parameter | perception | Sensory change |
| Headphones | High volume/ | Audio clarity, | Yes |
| | high bass | Active noise | |
| | | cancellation, No | |
| | | outside | |
| | | disturbance | |

The prolonged usage analyzer (152) then sends information associated with the one or more over-used capability parameters and changes in the one or more sensory perceptions to the sensory impact detector (153). At operation 405, the sensory impact detector (153) determines the level of impact on the one or more sensory perceptions of the user by correlating the one or more over-used capability parameters with the first period of time and the user profile using the one or more ML models and the duration of the impact associated with the one or more sensory perceptions of the user while accessing the first IoT device (100a) over the first period of time using the one or more ML models in response to determining that the one or more over-used capability parameters of the first IoT device (100), for example, as shown in Table 3.

TABLE 3

| Capability | | | |
|---|---|---|---|
| parameter | Sensory change | Impact Level | Impact duration |
| High volume/ | Low audio clarity | 56% | 1 Hour |
| High Bass | | | |

The sensory impact detector (153) then sends information associated with one or more over-used capability parameters, the level of impact on the one or more sensory perceptions of the user, and the duration of the impact associated with the one or more sensory perceptions of the user while accessing the first IoT device (100a) over the first period of time to the subsequent device usage predictor (154).

At operation 406, the subsequent device usage predictor (154) predicts the second IoT device (100b) (e.g., Television) in the IoT environment accessible by the user subsequent to the first IoT device (100a) based on the detected movement of the user towards the second IoT device (100b) using one or more sensors (e.g., Ultra-wideband (UWB) sensor) of the first IoT device (100a) and/or the second IoT device (100b), and/or the determined user intention to use the second IoT device (100b). The subsequent device usage predictor (154) determines the one or more affected capability parameters of the second IoT device (100b) that have an impact on the one or more sensory perceptions of the user while accessing the second IoT device (100b) due to prolonged use of the first IoT device (100a), for example, as shown in Table 4.

TABLE 4

| | User | User | |
|---|---|---|---|
| Second IoT device | Impact | experience | User experience impact |
| Television | Unclear | −70% | More source distance, content |
| | audio | | skip |

The subsequent device usage predictor (154) sends information associated with the second IoT device (100b) and one or more affected capability parameters to the sensory impact corrector (155). At operations 407, the subsequent device usage predictor (154) determines one or more counteracting capability parameters of the second IoT device (100b) to rectify the one or more affected capability parameters. The subsequent device usage predictor (154) then automatically configures the second IoT device (100b) from the first configuration to the second configuration based on the one or more determined counteracting capability parameters. The subsequent device usage predictor (154) then determines one or more correction values of the one or more counteracting capability parameters of the second IoT device (100b) using the one or more ML models. The subsequent device usage predictor (154) then automatically re-configures the second IoT device (100b) from the second configuration to the first configuration based on the one or more correction values and the one or more correction duration, for example, as shown in Table 5.

TABLE 5

| | Counteracting | Correction | Correction |
|---|---|---|---|
| Second IoT device | capability parameter | value | duration |
| Television | Live caption | On English | 1 hour |
| | | | prompt after |
| Television | Playback speed | 0.95x | 10 Min |

As a result, the second IoT device(s) (100b) is automatically configured/re-configured (e.g., live caption/playback speed) by the first IoT device (100a) to avoid discomfort because temporary sensory perception(s) changes caused by the first IoT device (100a), which improves user experience on subsequent second IoT device (100b).

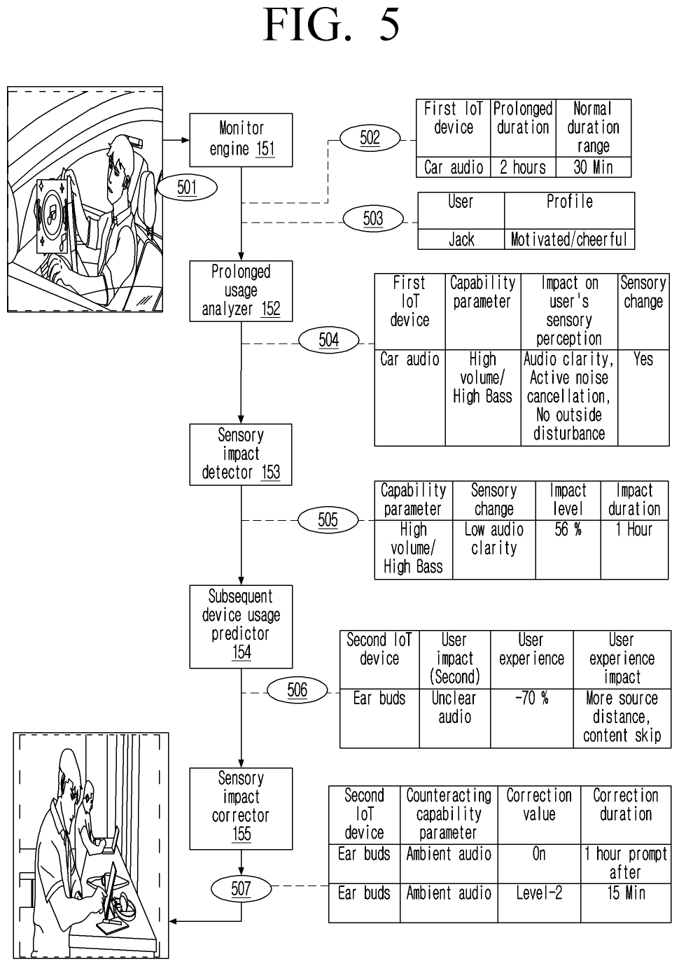

FIG. 5 is an example flow diagram illustrating various operations for handling the auditory sensory perception(s) of the user associated with the second IoT device(s) (100b), according to another embodiment as disclosed herein.

The user communicates with work while driving and listening to loud music. Due to traffic/distance, the user may listen to high bass music for an extended period of time. Because of their prolonged duration, the user may have Tinnitus/alter the user's auditory sensory perception(s). The user experience on the subsequent IoT device(s) (e.g., ear buds) that the user is about to use at the office is ruined by the temporary auditory sensory perception(s) changes caused by the loud music. To avoid this situation, the proposed method/electronic device (100) determines the subsequent IoT device(s) that the user may use based on a previous context, a user state, and a user location. To avoid discomfort caused by changes in auditory sensory perception, the proposed method/electronic device (100) will automatically configure/reconfigure the subsequent IoT device(s). The proposed method/electronic device (100) activates ambient audio in the ear buds. As a result, even when their ears are impacted by prolonged use of car audio, the user can clearly hear other people talking to him/her. The proposed method is explained in detail, operation by operation, below.

At operations 501-502, the monitor engine (151) determines the real-time usage duration of the first IoT device (100a) (for example, car audio) and the normal usage duration range of the first IoT device (100a). If the real-time usage duration exceeds the normal usage duration range, then the monitor engine (151) identifies the real-time usage duration of the first IoT device (100a) as the prolonged usage duration of the first IoT device (100a). For example, if the user uses the car audio system (100a) for the first period of time (for example, 2 hours) that exceeds the normal usage duration range (for example, 30 Min), the monitor engine (151) detects the prolonged use of the headphones (100a), for example, as shown in Table 6.

TABLE 6

| | Prolonged | Normal duration |
|---|---|---|
| First IoT device | usage duration | range |
| car audio | 2 hours | 30 Min |

At operation 503, the monitor engine (151) identifies the user profile. The monitor engine (151) then sends information associated with the prolonged usage duration of the first IoT device (100a) and the identified user profile to the prolonged usage analyzer (152). At operation 504, the prolonged usage analyzer (152) determines one or more over-used capability parameters of the first IoT device (100a) that has an impact on the one or more sensory perceptions of the user while accessing the first IoT device (100a) over the first period of time, which may have difficulty hearing audio, for example, as shown in Table 7.

TABLE 7

| | | Impact on user's | |
|---|---|---|---|
| | Capability | sensory | |
| First IoT device | parameter | perception | Sensory change |
| Car audio | High volume/ | Audio clarity, | Yes |
| | high bass | Active noise | |
| | | cancellation, No | |
| | | outside | |
| | | disturbance | |

The prolonged usage analyzer (152) then sends information associated with the one or more over-used capability parameters and changes in the one or more sensory perceptions to the sensory impact detector (153). At operation 505, the sensory impact detector (153) determines the level of impact on the one or more sensory perceptions of the user by correlating the one or more over-used capability parameters with the first period of time and the user profile using the one or more ML models and the duration of the impact associated with the one or more sensory perceptions of the user while accessing the first IoT device (100a) over the first period of time using the one or more ML models in response to determining that the one or more over-used capability parameters of the first IoT device (100), for example, as shown in Table 8.

TABLE 8

| Capability | | | |
|---|---|---|---|
| parameter | Sensory change | Impact Level | Impact duration |
| High volume/ | Low audio clarity | 56% | 1 Hour |
| High Bass | | | |

The sensory impact detector (153) then sends information associated with one or more over-used capability parameters, the level of impact on the one or more sensory perceptions of the user, and the duration of impact associated with the one or more sensory perceptions of the user while accessing the first IoT device (100a) over the first period of time to the subsequent device usage predictor (154).

At operation 506, the subsequent device usage predictor (154) predicts the second IoT device (100b) (e.g., Ear buds) in the IoT environment accessible by the user subsequent to the first IoT device (100a) based on the detected movement of the user towards the second IoT device (100b) using one or more sensors (e.g., location sensor) of the first IoT device (100a) and/or the second IoT device (100b), and/or the determined user intention to use the second IoT device (100b). The subsequent device usage predictor (154) determines the one or more affected capability parameters of the second IoT device (100b) that have an impact on the one or more sensory perceptions of the user while accessing the second IoT device (100b) due to prolonged use of the first IoT device (100a), for example, as shown in Table 9.

TABLE 9

| | User | User | |
|---|---|---|---|
| Second IoT device | Impact | experience | User experience impact |
| Ear buds | Unclear | −70% | More source distance, content |
| | audio | | skip |

The subsequent device usage predictor (154) sends information associated with the second IoT device (100b) and one or more affected capability parameters to the sensory impact corrector (155). At operations 507, the subsequent device usage predictor (154) determines one or more counteracting capability parameters of the second IoT device (100b) to rectify the one or more affected capability parameters. The subsequent device usage predictor (154) then automatically configures the second IoT device (100b) from the first configuration to the second configuration based on the one or more determined counteracting capability parameters. The subsequent device usage predictor (154) then determines one or more correction values of the one or more counteracting capability parameters of the second IoT device (100b) using the one or more ML models. The subsequent device usage predictor (154) then automatically re-configures the second IoT device (100b) from the second configuration to the first configuration based on the one or more correction values and the one or more correction duration, for example, as shown in Table 10.

TABLE 10

| | Counteracting | | |
|---|---|---|---|
| | capability | Correction | Correction |
| Second IoT device | parameter | value | duration |
| Ear buds | Ambient audio | On | 1 hour prompt |
| | | | after |
| Ear buds | Ambient audio | Level-2 | 15 Min |

As a result, the second IoT device(s) (100b) is automatically configured/re-configured (e.g., ambient audio) by the first IoT device (100a) to avoid discomfort because temporary sensory perception(s) changes caused by the first IoT device (100a), which improves user experience on subsequent second IoT device (100b).

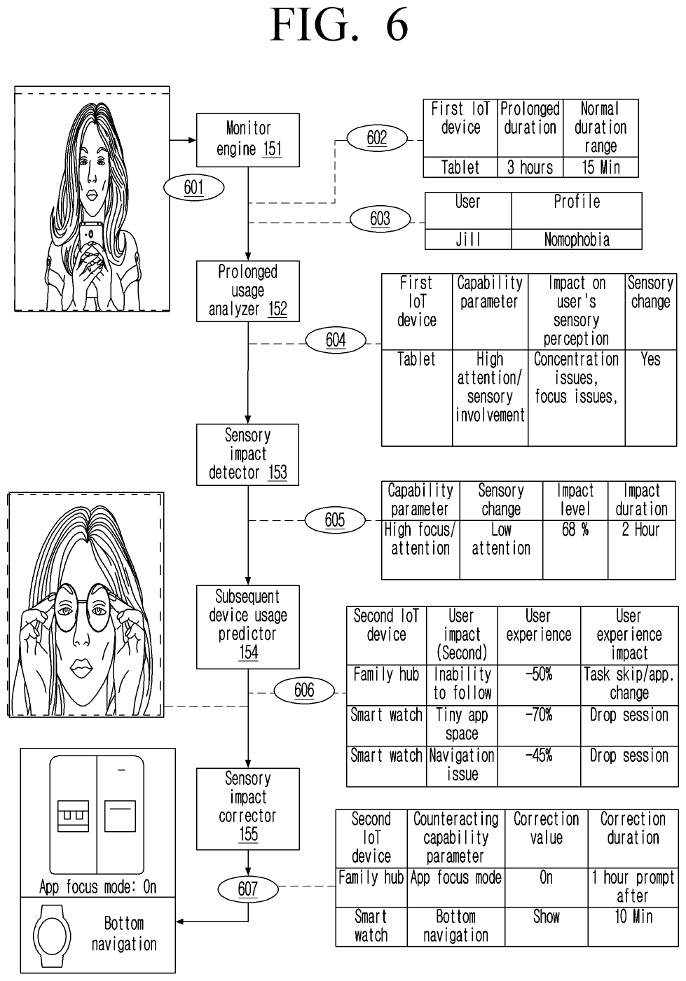

FIG. 6 is an example flow diagram illustrating various operations for handling a visual sensory perception(s) of the user associated with the second IoT device(s) (100b), according to an embodiment as disclosed herein.

The user has been browsing through social media for the prolonged duration and watching reels for over an hour now on a tablet/electronic device (100). Because of the prolonged duration, the user may have focus/concentration issues. The user experience on the subsequent IoT device(s) (e.g., family hub/smart watch) that the user is about to use at the home is ruined by the temporary visual sensory perception(s) changes caused by the watching reels for over the hour. To avoid this situation, the proposed method/electronic device (100) determines the subsequent IoT device(s) that the user may use based on the previous context, the user state, and the user location. To avoid discomfort caused by changes in visual sensory perception, the proposed method/electronic device (100) will automatically configure/reconfigure the subsequent IoT device(s). The proposed method/electronic device (100) activates bottom navigation mode on in smartphone and detects user is going to kitchen. So, the proposed method/electronic device (100) switches family hub in “App Focus mode”. As a result, the user is able to clearly understand a recipe and is able to pay attention due to less content being displayed. The proposed method is explained in detail, operation by operation, below.

At operations 601-602, the monitor engine (151) determines the real-time usage duration of the first IoT device (100a) (for example, Tablet) and the normal usage duration range of the first IoT device (100a). If the real-time usage duration exceeds the normal usage duration range, then the monitor engine (151) identifies the real-time usage duration of the first IoT device (100a) as the prolonged usage duration of the first IoT device (100a). For example, if the user uses the tablet (100a) for the first period of time (for example, 3 hours) that exceeds the normal usage duration range (for example, 15 Min), the monitor engine (151) detects the prolonged use of the headphones (100a), for example, as shown in Table 11.

TABLE 11

| First IoT | Prolonged | Normal duration |
|---|---|---|
| device | usage duration | range |
| Tablet | 3 hours | 15 Min |

At operation 603, the monitor engine (151) identifies the user profile. The monitor engine (151) then sends information associated with the prolonged usage duration of the first IoT device (100a) and the identified user profile to the prolonged usage analyzer (152). At operation 604, the prolonged usage analyzer (152) determines one or more over-used capability parameters of the first IoT device (100a) that has an impact on the one or more sensory perceptions of the user while accessing the first IoT device (100a) over the first period of time, for example, as shown in Table 12.

TABLE 12

| | | Impact on user's | |
|---|---|---|---|
| First IoT | Capability | sensory | Sensory |
| device | parameter | perception | change |
| Tablet | High | Concentration | Yes |
| | attention/sensory | issues, focus | |
| | involvement | issues, | |

The prolonged usage analyzer (152) then sends information associated with the one or more over-used capability parameters and changes in the one or more sensory perceptions to the sensory impact detector (153). At operation 605, the sensory impact detector (153) determines the level of impact on the one or more sensory perceptions of the user by correlating the one or more over-used capability parameters with the first period of time and the user profile using the one or more ML models and the duration of the impact associated with the one or more sensory perceptions of the user while accessing the first IoT device (100a) over the first period of time using the one or more ML models in response to determining that the one or more over-used capability parameters of the first IoT device (100), for example, as shown in Table 13.

TABLE 13

| Capability | Sensory | Impact | Impact |
|---|---|---|---|
| parameter | change | Level | duration |
| High focus/ | Low | 68% | 2 Hour |
| attention | attention | | |

The sensory impact detector (153) then sends information associated with one or more over-used capability parameters, the level of impact on the one or more sensory perceptions of the user, and the duration of impact associated with the one or more sensory perceptions of the user while accessing the first IoT device (100a) over the first period of time to the subsequent device usage predictor (154).

At operation 606, the subsequent device usage predictor (154) predicts the second IoT device (100b) (e.g., Family hub/smart watch) in the IoT environment accessible by the user subsequent to the first IoT device (100a) based on the detected movement of the user towards the second IoT device (100b) using one or more sensors (e.g., location sensor) of the first IoT device (100a) and/or the second IoT device (100b), and/or the determined user intention to use the second IoT device (100b). The subsequent device usage predictor (154) determines the one or more affected capability parameters of the second IoT device (100b) that have an impact on the one or more sensory perceptions of the user while accessing the second IoT device (100b) due to prolonged use of the first IoT device (100a), for example, as shown in Table 14.

TABLE 14

| Second IoT | User | User | |
|---|---|---|---|
| device | Impact | experience | User experience impact |
| Family hub | Inability to | −50% | Task skip/app. change |
| | follow | | |
| Smart watch | Tiny app | −70% | Drop session |
| | space | | |
| Smart watch | Navigation | −45% | Drop session |
| | issue | | |

The subsequent device usage predictor (154) sends information associated with the second IoT device (100b) and one or more affected capability parameters to the sensory impact corrector (155). At operations 607, the subsequent device usage predictor (154) determines one or more counteracting capability parameters of the second IoT device (100b) to rectify the one or more affected capability parameters. The subsequent device usage predictor (154) then automatically configures the second IoT device (100b) from the first configuration to the second configuration based on the one or more determined counteracting capability parameters. The subsequent device usage predictor (154) then determines one or more correction values of the one or more counteracting capability parameters of the second IoT device (100b) using the one or more ML models. The subsequent device usage predictor (154) then automatically re-configures the second IoT device (100b) from the second configuration to the first configuration based on the one or more correction values and the one or more correction duration, for example, as shown in Table 15.

TABLE 15

| | Counteracting | | |
|---|---|---|---|
| Second IoT | capability | Correction | Correction |
| device | parameter | value | duration |
| Family hub | App focus mode | On | 1 hour prompt |
| | | | after |
| Smart watch | Bottom | Show | 10 Min |
| | navigation | | |

As a result, the second IoT device(s) (100b) is automatically configured/re-configured (e.g., App focus mode) by the first IoT device (100a) to avoid discomfort because temporary sensory perception(s) changes caused by the first IoT device (100a), which improves user experience on subsequent second IoT device (100b).

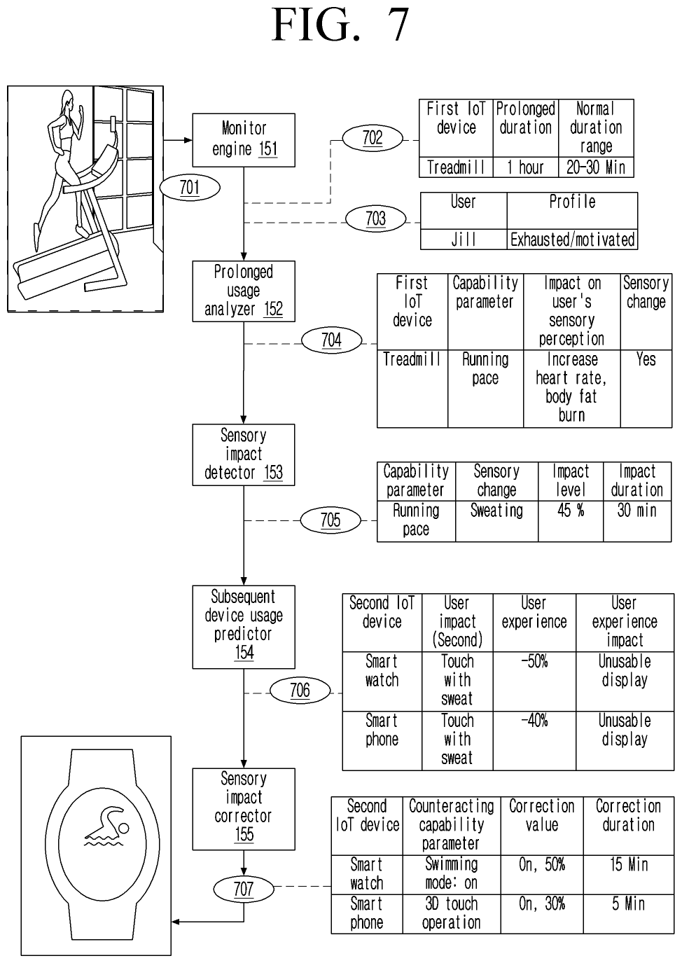

FIG. 7 is an example flow diagram illustrating various operations for handling a touch sensory perception(s) of the user associated with the second IoT device(s) (100b), according to an embodiment as disclosed herein.

The user has been running on the treadmill for the past 1 hour, using a treadmill for the prolonged duration. Because of the prolonged duration, the user's hands are sweaty. The temporary touch sensory perception(s) changes caused by running on the treadmill ruin the user experience on the subsequent IoT device(s) (e.g., smart watch) that the user is about to use. To avoid this situation, the proposed method/electronic device (100) determines the subsequent IoT device(s) that the user may use based on the previous context, the user state, and the user location. To avoid discomfort caused by changes in touch sensory perception, the proposed method/electronic device (100) will automatically configure/reconfigure the subsequent IoT device(s). The proposed method/electronic device (100) activates a 3D touch mode on in a smartphone/a swimming mode in a smart watch. So, the proposed method/electronic device (100) switches the smartphone in “3D touch mode” and/or the smart watch in “swimming mode”. As a result, the user is able to use the smartphone/smart (for example, second IoT device(s) (100b)) watch even with sweaty hands and when a sweat goes off, these modes are switched back to a prior mode (for example, first configuration). The proposed method is explained in detail, operation by operation, below.

At operations 701-702, the monitor engine (151) determines the real-time usage duration of the first IoT device (100a) (for example, Treadmill) and the normal usage duration range of the first IoT device (100a). If the real-time usage duration exceeds the normal usage duration range, then the monitor engine (151) identifies the real-time usage duration of the first IoT device (100a) as the prolonged usage duration of the first IoT device (100a). For example, if the user uses the Treadmill (100a) for the first period of time (for example, 1 hour) that exceeds the normal usage duration range (for example, 20-30 Min), the monitor engine (151) detects the prolonged use of the Treadmill (100a), for example, as shown in Table 16.

TABLE 16

| First IoT | Prolonged | Normal duration |
|---|---|---|
| device | usage duration | range |
| Treadmill | 1 hour | 20-30 Min |

At operation 703, the monitor engine (151) identifies the user profile. The monitor engine (151) then sends information associated with the prolonged usage duration of the first IoT device (100a) and the identified user profile to the prolonged usage analyzer (152). At operation 704, the prolonged usage analyzer (152) determines one or more over-used capability parameters of the first IoT device (100a) that has an impact on the one or more sensory perceptions of the user while accessing the first IoT device (100a) over the first period of time, for example, as shown in Table 17.

TABLE 17

| | | Impact on user's | |
|---|---|---|---|
| First IoT | Capability | sensory | |
| device | parameter | perception | Sensory change |
| Treadmill | Running pace | Increase heart | Yes |
| | | rate, body fat | |
| | | burn | |

The prolonged usage analyzer (152) then sends information associated with the one or more over-used capability parameters and changes in the one or more sensory perceptions to the sensory impact detector (153). At operation 705, the sensory impact detector (153) determines the level of impact on the one or more sensory perceptions of the user by correlating the one or more over-used capability parameters with the first period of time and the user profile using the one or more ML models and the duration of the impact associated with the one or more sensory perceptions of the user while accessing the first IoT device (100a) over the first period of time using the one or more ML models in response to determining that the one or more over-used capability parameters of the first IoT device (100), for example, as shown in Table 18.

TABLE 18

| Capability | | | |
|---|---|---|---|
| parameter | Sensory change | Impact Level | Impact duration |
| Running pace | Sweating | 45% | 30 min |

The sensory impact detector (153) then sends information associated with one or more over-used capability parameters, the level of impact on the one or more sensory perceptions of the user, and the duration of impact associated with the one or more sensory perceptions of the user while accessing the first IoT device (100a) over the first period of time to the subsequent device usage predictor (154).

At operation 706, the subsequent device usage predictor (154) predicts the second IoT device (100b) (e.g., smart phone/smart watch) in the IoT environment accessible by the user subsequent to the first IoT device (100a) based on the detected movement of the user towards the second IoT device (100b) using one or more sensors (e.g., location sensor) of the first IoT device (100a) and/or the second IoT device (100b), and/or the determined user intention to use the second IoT device (100b). The subsequent device usage predictor (154) determines the one or more affected capability parameters of the second IoT device (100b) that have an impact on the one or more sensory perceptions of the user while accessing the second IoT device (100b) due to prolonged use of the first IoT device (100a), for example, as shown in Table 19.

TABLE 19

| Second IoT | | User | |
|---|---|---|---|
| device | User Impact | experience | User experience impact |
| Smart watch | Touch with | −50% | Unusable display |
| | sweat | | |
| Smart phone | Touch with | −40% | Unusable display |
| | sweat | | |

The subsequent device usage predictor (154) sends information associated with the second IoT device (100b) and one or more affected capability parameters to the sensory impact corrector (155). At operations 707, the subsequent device usage predictor (154) determines one or more counteracting capability parameters of the second IoT device (100b) to rectify the one or more affected capability parameters. The subsequent device usage predictor (154) then automatically configures the second IoT device (100b) from the first configuration to the second configuration based on the one or more determined counteracting capability parameters. The subsequent device usage predictor (154) then determines one or more correction values of the one or more counteracting capability parameters of the second IoT device (100b) using the one or more ML models. The subsequent device usage predictor (154) then automatically re-configures the second IoT device (100b) from the second configuration to the first configuration based on the one or more correction values and the one or more correction duration, for example, as shown in Table 20.

TABLE 20

| | Counteracting | | |
|---|---|---|---|
| Second IoT | capability | Correction | Correction |
| device | parameter | value | duration |
| Smart watch | Swimming mode: | On, 50% | 15 Min |
| | on | | |
| Smart phone | 3D touch | On, 30% | 5 Min |
| | operation | | |

As a result, the second IoT device(s) (100b) is automatically configured/re-configured (e.g., swimming mode/3D touch operation) by the first IoT device (100a) to avoid discomfort because of temporary sensory perception(s) changes caused by the first IoT device (100a), which improves user experience on subsequent second IoT device (100b).

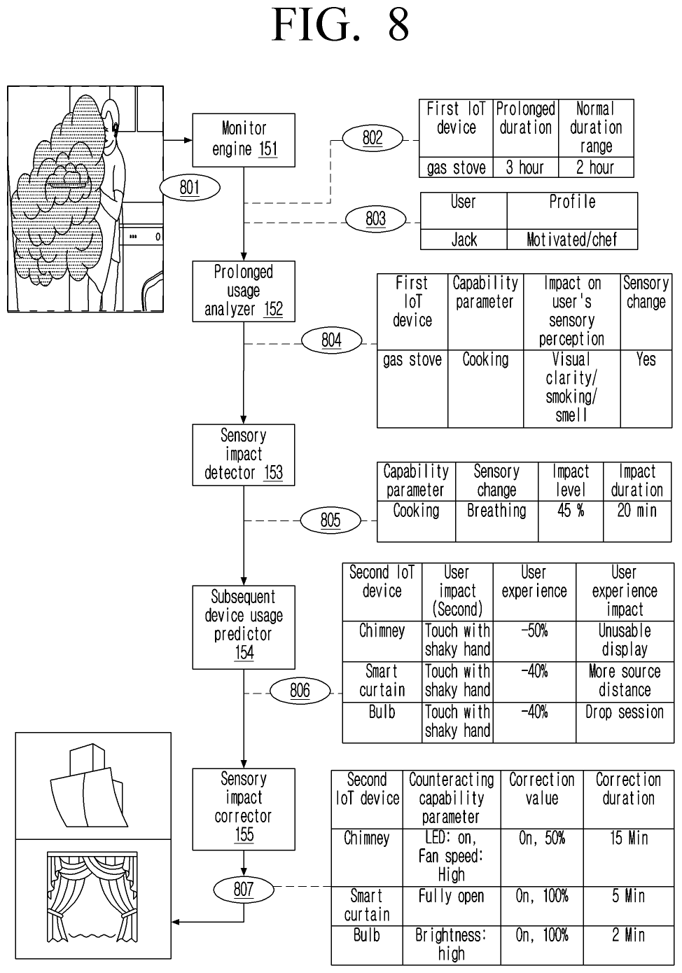

FIG. 8 is an example flow diagram illustrating various operations for handling the visual sensory perception(s) of the user associated with the second IoT device(s) (100b), according to another embodiment as disclosed herein.

The user has been cooking in the kitchen for the prolong duration and is using chimney for the prolong duration. Because of the prolonged duration, the user's hands are sweaty. The temporary visual sensory perception(s) changes caused by cooking in the kitchen for the prolong duration ruin the user experience on the subsequent IoT device(s) that the user is about to use. To avoid this situation, the proposed method/electronic device (100) determines impact on user's sensory perception that user's vision might not be proper due to all a smoke in the kitchen and determines the subsequent IoT device(s) that the user may use based on the previous context, the user state, and the user location. To avoid discomfort caused by changes in visual sensory perception, the proposed method/electronic device (100) will automatically configure/reconfigure the subsequent IoT device(s). The proposed method/electronic device (100) switches on chimney and turns the LED lights on and operates chimney in a full speed mode and opens curtains. As a result, the user is able to clearly see the kitchen room and other areas in the kitchen despite the vision affected by smoke in the kitchen. The proposed method is explained in detail, operation by operation, below.

At operations 801-802, the monitor engine (151) determines the real-time usage duration of the first IoT device (100a) (for example gas stove) and the normal usage duration range of the first IoT device (100a). If the real-time usage duration exceeds the normal usage duration range, then the monitor engine (151) identifies the real-time usage duration of the first IoT device (100a) as the prolonged usage duration of the first IoT device (100a). For example, if the user uses the gas stove (100a) for the first period of time (for example 3 hour) that exceeds the normal usage duration range (for example 2 Hour), the monitor engine (151) detects the prolonged use of the gas stove (100a), for example, as shown in Table 21.

TABLE 21

| | Prolonged | Normal duration |
|---|---|---|
| First IoT device | usage duration | range |
| gas stove | 3 hour | 2 hour |

At operation 803, the monitor engine (151) identifies the user profile. The monitor engine (151) then sends information associated with the prolonged usage duration of the first IoT device (100a) and the identified user profile to the prolonged usage analyzer (152). At operation 804, the prolonged usage analyzer (152) determines one or more over-used capability parameters of the first IoT device (100a) that has an impact on the one or more sensory perceptions of the user while accessing the first IoT device (100a) over the first period of time, for example, as shown in Table 22.

TABLE 22

| | | Impact on user's | |
|---|---|---|---|
| First IoT | Capability | sensory | |
| device | parameter | perception | Sensory change |
| gas stove | Cooking | Visual | Yes |
| | | clarity/smoking/ | |
| | | smell | |

The prolonged usage analyzer (152) then sends information associated with the one or more over-used capability parameters and changes in the one or more sensory perceptions to the sensory impact detector (153). At operation 805, the sensory impact detector (153) determines the level of impact on the one or more sensory perceptions of the user by correlating the one or more over-used capability parameters with the first period of time and the user profile using the one or more ML models and the duration of the impact associated with the one or more sensory perceptions of the user while accessing the first IoT device (100a) over the first period of time using the one or more ML models in response to determining that the one or more over-used capability parameters of the first IoT device (100), for example, as shown in Table 23.

TABLE 23

| Capability | | | |
|---|---|---|---|
| parameter | Sensory change | Impact Level | Impact duration |
| Cooking | Breathing | 45% | 20 min |

The sensory impact detector (153) then sends information associated with one or more over-used capability parameters, the level of impact on the one or more sensory perceptions of the user, and the duration of impact associated with the one or more sensory perceptions of the user while accessing the first IoT device (100a) over the first period of time to the subsequent device usage predictor (154).

At operation 806, the subsequent device usage predictor (154) predicts the second IoT device (100b) (e.g., smart phone/smart watch) in the IoT environment accessible by the user subsequent to the first IoT device (100a) based on the detected movement of the user towards the second IoT device (100b) using one or more sensors (e.g., location sensor) of the first IoT device (100a) and/or the second IoT device (100b), and/or the determined user intention to use the second IoT device (100b). The subsequent device usage predictor (154) determines the one or more affected capability parameters of the second IoT device (100b) that have an impact on the one or more sensory perceptions of the user while accessing the second IoT device (100b) due to prolonged use of the first IoT device (100a), for example, as shown in Table 24.

TABLE 24

| Second IoT | | User | |
|---|---|---|---|
| device | User Impact | experience | User experience impact |
| Chimney | Touch with | −50% | Unusable |
| | shaky hand | | display |
| Smart | Touch with | −40% | More source |
| curtain | shaky hand | | distance |
| Bulb | Touch with | −40% | Drop |
| | shaky hand | | session |

The subsequent device usage predictor (154) sends information associated with the second IoT device (100b) and one or more affected capability parameters to the sensory impact corrector (155). At operations 807, the subsequent device usage predictor (154) determines one or more counteracting capability parameters of the second IoT device (100b) to rectify the one or more affected capability parameters. The subsequent device usage predictor (154) then automatically configures the second IoT device (100b) from the first configuration to the second configuration based on the one or more determined counteracting capability parameters. The subsequent device usage predictor (154) then determines one or more correction values of the one or more counteracting capability parameters of the second IoT device (100b) using the one or more ML models. The subsequent device usage predictor (154) then automatically re-configures the second IoT device (100b) from the second configuration to the first configuration based on the one or more correction values and the one or more correction duration, for example, as shown in Table 25.

TABLE 25

| | Counteracting | | |
|---|---|---|---|
| Second IoT | capability | Correction | Correction |
| device | parameter | value | duration |
| Chimney | LED: on, | On, 50% | 15 Min |
| | Fan speed: High | | |
| Smart curtain | Fully open | On, 100% | 5 Min |
| Bulb | Brightness: high | On, 100% | 2 Min |

As a result, the second IoT device(s) (100b) is automatically configured/re-configured (e.g., LED on, fan high-speed, for example) by the first IoT device (100a) to avoid discomfort because temporary sensory perception(s) changes caused by the first IoT device (100a), which improves user experience on subsequent second IoT device (100b).

The embodiments disclosed herein can be implemented using at least one hardware device and performing network management functions to control the elements.

The foregoing description of the embodiments will so fully reveal the nature of the embodiments herein that others can, by applying current knowledge, readily modify and/or adapt for various applications without departing from the concept, and, such adaptations and modifications should and are intended to be comprehended within the meaning and range of equivalents of the disclosed embodiments. It is to be understood that the phraseology or terminology employed herein is for the purpose of description and not of limitation. While the embodiments herein have been described, those skilled in the art will recognize that the embodiments herein can be practiced with modification within the scope of the disclosure.

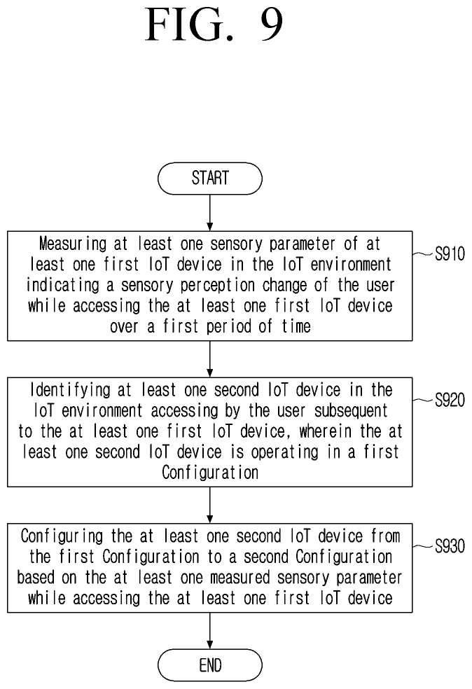

FIG. 9 is an example flow diagram illustrating various operations for handling (or controlling, changing, adjusting) the visual sensory perception(s) of the user associated with the second IoT device(s) (100b), according to another embodiment as disclosed herein.

Accordingly, embodiments herein disclose a controlling method of an electronic device (100) for handling sensory perception of a user in an Internet of Things (IoT) environment, wherein the method comprises measuring (or identifying or obtaining), by an electronic device (100) in the IoT environment, at least one sensory parameter of at least one first IoT device (100a) in the IoT environment indicating a sensory perception change of the user while accessing (or connecting) the at least one first IoT device (100a) over a first period of time (S910), identifying, by the electronic device (100), at least one second IoT device (100b) in the IoT environment accessing by the user subsequent to the at least one first IoT device, wherein the at least one second IoT device (100b) is operating in a first configuration (S920), and configuring (or controlling), by the electronic device (100), the at least one second IoT device (100b) from the first configuration to a second configuration based on the at least one measured sensory parameter while accessing the at least one first IoT device (100a) (S930).

The visual sensory perception(s) may include perception information. The perception information includes at least one of the visual sensory perception(s) or audial sensory perception(s).

The sensory perception may be described as sensory awareness or sensory experience.

The first period of time may be described as the first time, the first period, the first time information, the first period information, the first time interval or the first interval.

The sensory parameter may include information related to function of IoT devices.

The sensory parameter may be described as the parameter, the parameter information, the pre-determined parameter or the capability parameter.

The identifying method further comprises identifying, by the electronic device (100) or the at least one second IoT device, whether a second period of time is reached at which the changed sensory perception of the user reverts back to a prior state while accessing the at least one second IoT device. The method further comprises re-configuring, by the electronic device (100) or the at least one second IoT device, the at least one second IoT device (100b) from the second configuration to the first configuration in response to determining that the second period of time is reached.

The second period of time may be described as the second time, the second period, the second time information, the second period information, the second time interval or the second interval.

The identifying method further comprises identifying whether the second period of time is reached at which the changed sensory perception of the user corresponds a prior state while accessing the at least one second IoT device.

The prior state may be described as the pre-determined state, the first state or the previous state.

The configuring method further comprises 1) determining, by the electronic device (100), a level of an impact on the sensory perception of the user in relation to the first period of time, 2) determining, by the electronic device (100), a discomfort of the user to operate the at least one second IoT device (100b) by correlating at least one sensory parameter of the at least one second IoT device (100b) with the level of the impact on the sensory perception, 3) determining, by the electronic device (100), a duration of the impact on the sensory perception of the user due to accessing the at least one first IoT device (100a) over the first period of time, 4) determining, by the electronic device (100), at least one sensory parameter of the at least one second IoT device (100b) that can impact on the sensory perception of the user while accessing the at least one second IoT device (100b) subsequent to the at least one first IoT device, 5) determining, by the electronic device (100), at least one counteracting sensory parameter of the at least one second IoT device (100b) to rectify the impact on the sensory perception based on the determined sensory parameter of the at least one second IoT device, 6) determining, by the electronic device (100), the second configuration for the at least one second IoT device (100b) based on the duration of the impact on the sensory perception of the user and the at least one determined counteracting sensory parameter, wherein the second configuration for the at least one second IoT device (100b) is determined to avoid the discomfort of the user to operate the at least one second IoT device, and configuring, by the electronic device (100), the at least one second IoT device (100b) to the determined second configuration from the first configuration.

The sensory parameter may be described as the first sensory parameter or the first parameter.

The counteracting sensory parameter may be described as the second sensory parameter or the second parameter.

The discomfort may be described as the pre-determined event. The pre-determined event may include an event that the user is identified as uncomfortable. The discomfort may be caused by the sudden change in the sensory parameter(s). The pre-determined event may include an event that the sudden change in the sensory parameter(s).

The method determining method further comprises 1) determining, by the electronic device (100), a user profile, correlating, by the electronic device (100), the at least one sensory parameter of the at least one first IoT device (100a) with the first period of time and the user profile, and 2) determining, by the electronic device (100), the level of impact based on the correlation.

The user profile may include various information related to the user. The user profile may include at least one of name, age, sex, identification information or user history.

The level of impact on the sensory perception of the user in relation to the first period of time is determined by using at least one Machine Learning (ML) model.

The level of impact may be described as the level, the impact level, the impact information.

The impact may be described as the influence, the effect or the consequence.

The correlating expressions may be excluded.

The method further comprises measuring (or obtaining) impact information. The impact information may include at least one of impact level or impact duration.

The measuring method further comprises identifying, by the electronic device (100), a plurality of sensory parameters of the at least one first IoT device (100a) while using the at least one first IoT device, determining, by the electronic device (100), one or more sensory parameters in the plurality of sensory parameters meets (or matches or corresponds) the first period of time while using the at least one first IoT device, and measuring, by the electronic device (100), the at least one sensory parameter in the one or more sensory parameters while using the at least one first IoT device.

The identifying method further comprises identifying, by the electronic device (100), a movement of the user towards the at least one second IoT device (100b) using at least one sensor of the electronic device (100) or IoT devices in the IoT environment, determining, by the electronic device (100), a user intention to use the at least one second IoT device (100b) based on at least one of a past (or previous) user interaction with the at least one second IoT device (100b) and current context of the at least one first IoT device (100a) or the electronic device (100), and predicting (or determining) by the electronic device (100), the at least one second IoT device (100b) in the IoT environment accessible (or connectable) by the user subsequent to the at least one first IoT device (100a) based on the identified movement or the determined user intention.

The movement may be described as the moving information or the movement information.

The user interaction may be described as the user action.

The re-configuring method further comprises determining, by the electronic device (100) or the at least one second IoT device, at least one correction value of at least one counteracting sensory parameter of the at least one second IoT device (100b) using at least one Machine Learning (ML) model, determining, by the electronic device (100) or the at least one second IoT device, the second period of time based on the at least one determined correction value, and re-configuring, by the electronic device (100) or the at least one second IoT device, the at least one second IoT device (100b) to the first configuration from the second configuration, based on the determined second period of time being reached after which the at least one sensory parameter does not indicate the sensory perception change of the user while accessing the at least one second IoT device.

The first period of time may indicate a prolonged usage of the at least one first IoT device (100a) by the user in the IoT environment, and the prolonged usage of the at least one first IoT device (100a) is determined based on a real-time usage duration of the at least one first IoT device, a reference usage duration of the at least one first IoT device, a user profile, and current contextual parameter.

The prolonged usage may include behavior that use longer than preset time. A time that is measured when the first device is used for more than the preset time.

The real-time usage duration of the at least one first IoT device (100a) may be determined based on at least one real-time sensor data of the at least one first IoT device, and the reference usage duration of the at least one first IoT device (100a) is determined based on at least one pre-defined global usage data.

The method further comprises configuring the at least one second IoT device (100b) from the first configuration to the second configuration to minimize (or avoid or remove) the discomfort caused by a sudden change in the sensory parameters.

The configuration (first and second configuration) may be setting information related to the IoT device (first and second IoT device). For example, the configuration may include a output volume of speaker, a output brightness of display or a mode related power consumption.

Accordingly, embodiments herein disclose the electronic device (100) for handling sensory perception of a user in an Internet of Things (IoT) environment, wherein the electronic device (100) comprises a memory (110), a processor (120) coupled to the memory (110), a communicator (130) coupled to the memory (110) and the processor (120), a controller (150) coupled to the memory (110), the processor (120) and the communicator (130), wherein the controller is configured to measure at least one sensory parameter of at least one first IoT device (100a) in the IoT environment indicating a sensory perception change of the user while accessing the at least one first IoT device (100a) over a first period of time, identify at least one second IoT device (100b) in the IoT environment accessing by the user subsequent to the at least one first IoT device, wherein the at least one second IoT device (100b) is operating in a first configuration, and change the at least one second IoT device (100b) from the first configuration to a second configuration based on the at least one measured sensory parameter while accessing the at least one first IoT device.

The controller is further configured to identify whether a second period of time is reached at which the changed sensory perception of the user reverts back to a prior state while accessing the at least one second IoT device, and change the at least one second IoT device (100b) from the second configuration to the first configuration in response to determining that the second period of time is reached.

The controller is further configured to determine a level of an impact on the sensory perception of the user in relation to the first period of time, determine a discomfort of the user to operate the at least one second IoT device (100b) by correlating at least one sensory parameter of the at least one second IoT device (100b) with the level of the impact on the sensory perception, determine a duration of the impact on the sensory perception of the user due to accessing the at least one first IoT device (100a) over the first period of time, determine at least one sensory parameter of the at least one second IoT device (100b) that can impact on the sensory perception of the user while accessing the at least one second IoT device (100b) subsequent to the at least one first IoT device, determine at least one counteracting sensory parameter of the at least one second IoT device (100b) to rectify the impact on the sensory perception based on the determined sensory parameter of the at least one second IoT device, determine the second configuration for the at least one second IoT device (100b) based on the duration of the impact on the sensory perception of the user and the at least one determined counteracting sensory parameter, wherein the second configuration for the at least one second IoT device (100b) is determined to avoid the discomfort of the user to operate the at least one second IoT device, and change the at least one second IoT device (100b) to the determined second configuration from the first configuration.

The controller is further configured to determine a user profile, correlate the at least one sensory parameter of the at least one first IoT device (100a) with the first period of time and the user profile, and determine the level of impact based on the correlation.

What is claimed is:

1. A control method of an electronic device for handling determined sensory perception changes of a user in an Internet of Things (IoT) environment, the control method comprising:
measuring at least one first sensory parameter of at least one first IoT device in the IoT environment, wherein the at least one first sensory parameter indicates a determined sensory perception change of the user based on the user using the at least one first IoT device over a first period of time;
identifying at least one second IoT device in the IoT environment used by the user after the at least one first IoT device, wherein the at least one second IoT device is operating in a first configuration; and
controlling the at least one second IoT device to switch from the first configuration to a second configuration based on the at least one first sensory parameter.

2. The control method as claimed in claim 1, further comprising:
based on the user using the at least one second IoT device, identifying whether a second period of time is reached indicating the determined sensory perception change of the user has reverted to a prior state; and
controlling, based on the second period of time being reached, the at least one second IoT device to switch from the second configuration to the first configuration.

3. The control method as claimed in claim 1, wherein the controlling the at least one second IoT device to switch from the first configuration to the second configuration comprises:
determining an impact level of the first period of time on the determined sensory perception of the user;
determining a discomfort level for operating the at least one second IoT device based on a first relationship between at least one second sensory parameter of the at least one second IoT device and the impact level;
determining an impact duration for the impact level based on the first period of time;
determining at least one third sensory parameter of the at least one second IoT device affecting the determined sensory perception of the user while using the at least one second IoT device;
determining, based on the at least one third sensory parameter, at least one counteracting sensory parameter of the at least one second IoT device for offsetting the impact level;
determining the second configuration based on the impact duration and the at least one counteracting sensory parameter such that the discomfort level is reduced; and
controlling the at least one second IoT device to switch from the first configuration to the second configuration.

4. The control method as claimed in claim 3, wherein determining the impact level comprises:
determining a user profile;
determining, based on the user profile, a second relationship between the at least one first sensory parameter and the first period of time; and
determining the impact level based on the second relationship.

5. The control method as claimed in claim 3, wherein the impact level is determined based on at least one Machine Learning (M L) model.

6. The control method as claimed in claim 1, wherein the measuring the at least one first sensory parameter comprises:
identifying a first plurality of sensory parameters of the at least one first IoT device based on the user using the at least one first IoT device;
determining one or more sensory parameters from among the first plurality of sensory parameters corresponding to the first period of time, wherein the one or more sensory parameters comprise the at least one first sensory parameter; and
measuring the at least one first sensory parameter.

7. The control method as claimed in claim 1, wherein the identifying the at least one second IoT device comprises:
identifying, based on receiving information from at least one sensor of an IoT device in the IoT environment, a movement of the user toward the at least one second IoT device;
determining a user intent based on at least one of past user interaction data for the at least one second IoT device and current context data of the electronic device or received from the at least one first IoT device; and
predicting the at least one second IoT device based on at least one of the movement or the user intent.

8. The control method as claimed in claim 2, wherein controlling the at least one second IoT device to switch from the second configuration to the first configuration comprises:
determining, based on at least one Machine Learning (ML) model, at least one correction value of at least one counteracting sensory parameter of the at least one second IoT device;
determining the second period of time based on the at least one correction value; and
based on the second period of time being reached, controlling the at least one second IoT device to switch to the first configuration from the second configuration, wherein at least one second sensory parameter of the at least one second IoT device does not indicate the determined sensory perception change.

9. The control method as claimed in claim 1, wherein the first period of time indicates a prolonged usage of the at least one first IoT device by the user in the IoT environment, and wherein the prolonged usage is determined based on a real-time usage duration of the at least one first IoT device, a reference usage duration of the at least one first IoT device, a user profile, and current contextual parameter.

10. The control method as claimed in claim 9, wherein the real-time usage duration is determined based on real-time sensor data received from the at least one first IoT device, and the reference usage duration is determined based on pre-defined global usage data.

11. The control method as claimed in claim 1, wherein the control method further comprises controlling the at least one second IoT device to switch from the first configuration to the second configuration such that an increase in a discomfort level caused by a sudden change between the at least one first sensory parameter and at least one second sensory parameter of the at least one second IoT device is reduced.

12. An electronic device for handling determined sensory perception changes of a user in an Internet of Things (IoT) environment, the electronic device comprising:
memory storing instructions; and
one or more processors,
wherein the instructions, when executed by the one or more processors, cause the electronic device to:
measure at least one first sensory parameter of at least one first IoT device in the IoT environment, wherein the at least one first sensory parameter indicates a determined sensory perception change of the user based on the user using the at least one first IoT device over a first period of time;
identify at least one second IoT device in the IoT environment used by the user after the at least one first IoT device, wherein the at least one second IoT device is operating in a first configuration; and
control the at least one second IoT device to switch from the first configuration to a second configuration based on the at least one first sensory parameter.

13. The electronic device as claimed in claim 12, wherein the instructions, when executed by the one or more processors, further cause the electronic device to:
based on the user using the at least one second IoT device, identify whether a second period of time is reached indicating the determined sensory perception change of the user has reverted to a prior state; and
control, based on the second period of time being reached, the at least one second IoT device to switch from the second configuration to the first configuration.

14. The electronic device as claimed in claim 12, wherein the instructions, when executed by the one or more processors, cause the electronic device to:
determine an impact level of the first period of time on the determined sensory perception of the user;
determine a discomfort level for operating the at least one second IoT device based on a first relationship between at least one second sensory parameter of the at least one second IoT device and the impact level;
determine an impact duration for the impact level based on the first period of time;
determine at least one third sensory parameter of the at least one second IoT device affecting the determined sensory perception of the user while using the at least one second IoT device;
determine, based on the at least one third sensory parameter, at least one counteracting sensory parameter of the at least one second IoT device for offsetting the impact level;
determine the second configuration based on the impact duration and the at least one counteracting sensory parameter such that the discomfort level is reduced; and
control the at least one second IoT device to switch from the first configuration to the second configuration.

15. The electronic device as claimed in claim 14, wherein the instructions, when executed by the one or more processors, cause the electronic device to:
determine a user profile;
determine, based on the user profile, a second relationship between the at least one first sensory parameter and the first period of time; and
determine the impact level based on the second relationship.
